(19) United States
(12) Patent Application Publication
(10) Pub. No.: US 2006/0197328 A1
(43) Pub. Date: Sep. 7, 2006

(54) Expandable airbag cushion assembly

(75) Inventor: Jerome Bosch, Clinton Township, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/071,801

(22) Filed: Mar. 4, 2005

(51) Int. Cl. B60R 21/16

(52) U.S. Cl. 280/743.1

(57) ABSTRACT

An expandable airbag cushion assembly includes an internal inflatable pouch enclosed in an expandable external pocket and an inflator for directing gas into the internal inflatable pouch. The airbag cushion assembly may be enclosed in a flat panel casing that does not require the folding of the expandable external pocket when the airbag is deflated. The packaging size of an airbag assembly is relatively small compared to other airbag assemblies known the art. The smaller packaging size provides a car manufacturer with increased flexibility concerning the installation location of a vehicle airbag assembly. In turn, the capability to install an airbag in more locations within a passenger compartment provides the vehicle's occupants with better protection in the case of a collision.

### BACKGROUND

The present invention is generally related to driver protection devices in automobiles. More specifically, the present invention is related to airbags.

Inflatable airbags have become standard equipment in modern automobiles. Airbag devices, such as driver seat airbag devices and passenger seat airbag devices, are widely used to protect passengers from the impact produced during a vehicle collision. A driver seat airbag device is typically mounted on a boss of a steering wheel and includes a gas injecting inflator, an airbag, and a cover accommodating the airbag in a folded state. During collision of the vehicle, the gas injected from the inflator inflates the airbag. This ruptures the cover, which is made of a soft resin, and forms an opening in the cover. Accordingly, the airbag is inflated through the opening toward the vehicle's driver.

Typically, airbag devices are mounted in the steering wheel, the passenger dashboard and other locations in the vehicle to prevent passenger trauma in the case of a collision. However, conventional airbag assemblies of this nature are limited by there size since they generally require a large amount of space and depth to install.

The demand for space is due to the fact that the airbag is mounted in a deflated state. A deflated airbag is usual folded into the airbag assembly. When the airbag is deployed, the gas pumped into the airbag unfolds the airbag. Thus, a need exists for an airbag assembly possessing a smaller installation footprint that will allow automakers increased flexibility in where they may install airbags in a vehicle.

### SUMMARY

One embodiment of the present invention relates to an expandable airbag cushion assembly comprising an internal inflatable pouch enclosed in an expandable external pocket and an inflator for directing gas into the internal inflatable pouch, wherein the airbag cushion assembly may be enclosed in a flat panel casing that does not require the folding of the expandable external pocket when deflated.

In another embodiment of the present invention, the internal inflatable pouch is comprised of material having a high stretching coefficient.

In still another embodiment of the present invention, the expandable external pocket is capable of expanding a certain value before reaching a mechanical limit.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1 is a top view of an internal inflatable pouch according to one embodiment of the present invention.

FIG. 2 is a top view of an external inflatable pouch according to another embodiment of the present invention.

FIG. 3 is a perspective view of the airbag inflator assembly according to one embodiment of the present invention.

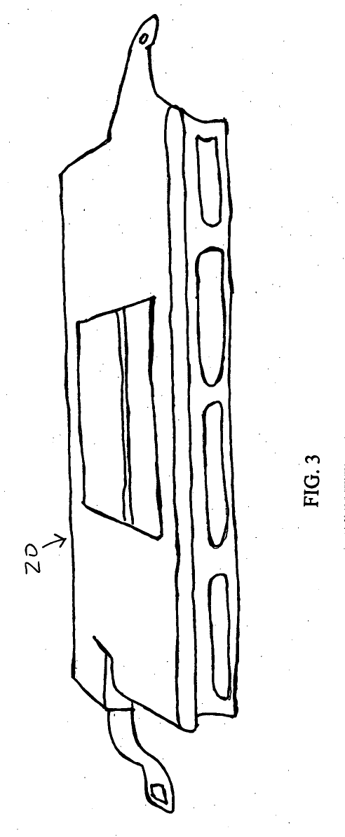

FIG. 4 is a perspective view of the airbag assembly after being inflated according to another embodiment of the present invention.

FIG. 5 is a top view of the airbag assembly after being inflated according to another embodiment of the present invention.

### DETAILED DESCRIPTION

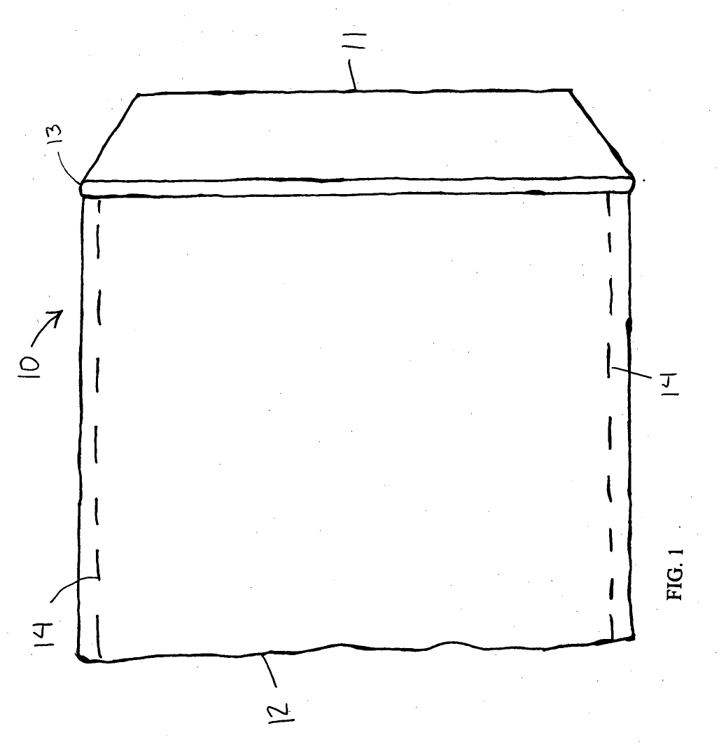

According to one embodiment of the present invention, an internal inflatable pouch 10 of an airbag cushion assembly 1 is seen in FIG. 1. The internal inflatable pouch 10 has an inflator receiving portion 11 for receiving an inflator 20 (not shown). Opposite the inflator receiving portion 11 is an inflatable portion 12. The inflatable portion 12 is arranged such that gas dispensed by the inflator 20 is directed into the inflatable portion 12. The inflatable portion 12 and the inflator receiving portion 11 are connected via a connection seem 13.

According to another embodiment of the present invention, the inflatable portion 12 has two edges and a periphery seem 14 located at each edge.

In still another embodiment of the invention, the material used for the internal inflatable pouch 10 has a high stretching coefficient allowing its internal volume (and therefore its surface area) to increase under the pressure generated by the inflator gases.

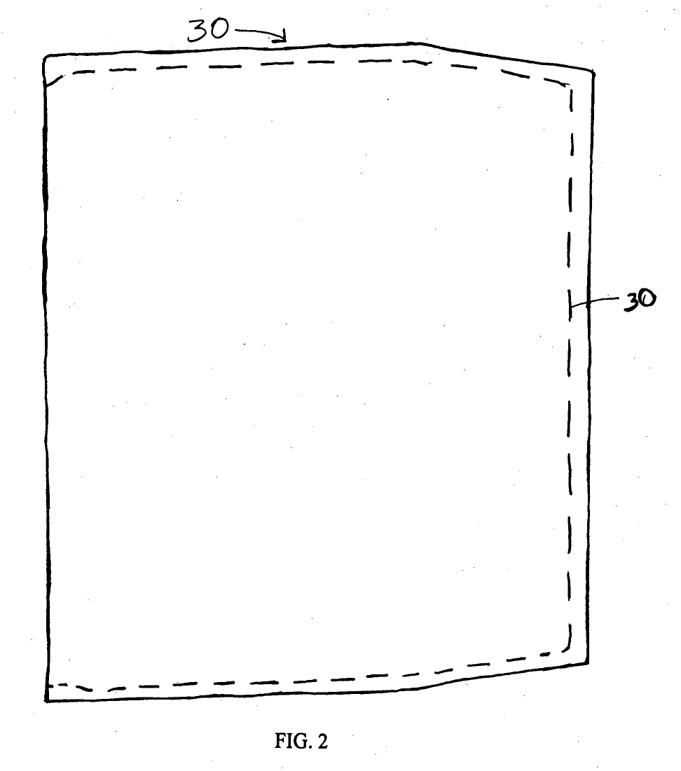

According to yet another embodiment of the present invention, an expandable external pocket 30 for an airbag cushion assembly 1 is shown in FIG. 2. Preferably, the expandable external pocket 30 is shaped, to accommodate the internal inflatable pouch 10. However, the expandable external pocket 30 is slightly larger than the internal inflatable pouch 10 so that the internal inflatable pouch 10 may be inserted into the external expandable pouch 30. The external expandable pocket 30 has a periphery seem 31 and is configured so that the external expandable pocket 30 encloses the internal inflatable pouch 10 entirely.

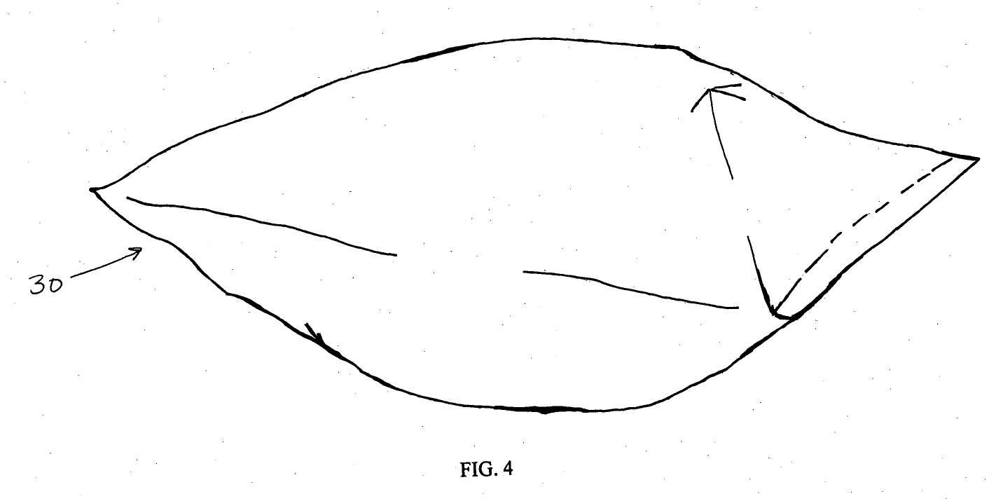

In still another embodiment of the present invention as seen in FIGS. 2 and 4-5, the external expandable pocket 30 is constructed from material that can only expand by a certain value before reaching a mechanical limit where expansion stops. The expandable external pocket 30 also serves to protect the internal inflatable pouch 10, which, because of its material, is more susceptible to damage.

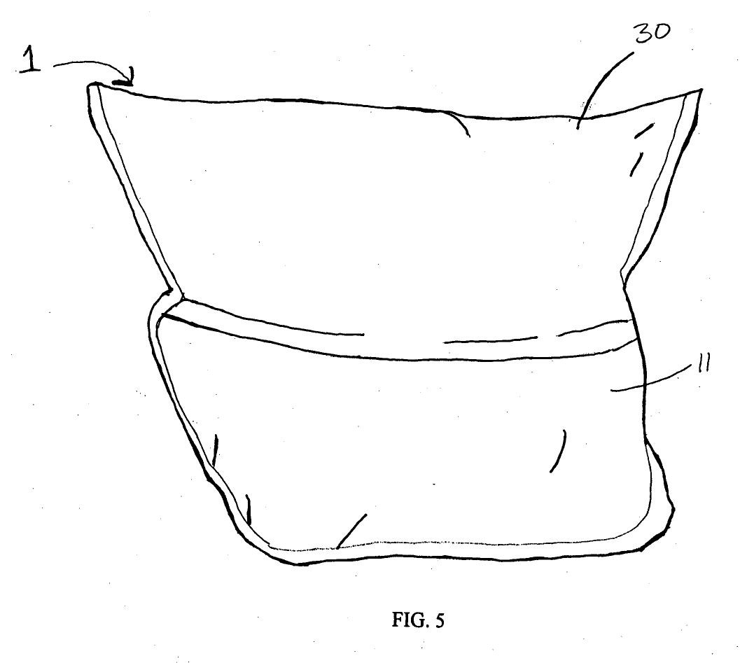

As seen in FIG. 5, according to another embodiment of the invention, the inflator 20 is configured to be placed in the inflator receiving portion 11. According to still another aspect of the invention, the inflator 20 may be remotely located. A tube (not shown) is configured to carry gas from the inflator 20 into the inflator receiving portion 11.

According to certain aspects of the invention, certain advantages are realized. The packaging size of an airbag assembly according to one embodiment of the invention is relatively small compared to other airbag assemblies known the art. The smaller packaging provides a car manufacturer with increased flexibility concerning the installation location a vehicle the airbag assembly. In turn, the capability to install an airbag in more locations within a passenger compartment provides vehicle occupants with better protection in the case of a collision. Further, the airbag cushion does not need to be folded to be installed properly. This attribute is likely to reduce the complexity involved with assembly of the airbag cushion assembly and lower production costs and time.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An expandable airbag cushion assembly comprising:
an expandable external pocket;
an internal inflatable pouch located in the expandable external pocket; and
an inflator for directing gas into the internal pouch.

2. An expandable airbag cushion assembly as in claim 1, wherein the internal inflatable pouch is comprised of material having a high stretching coefficient.

3. An expandable airbag cushion assembly as in claim 1, wherein the expandable external pocket is capable of expanding a certain value before reaching a mechanical limit and stop expanding.

4. An expandable airbag cushion assembly as in claim 1, wherein the internal inflatable pouch includes a receiving portion for holding the inflator.

5. An expandable airbag cushion assembly as in claim 1, wherein the external inflatable pouch includes an opening for receiving a connection to the inflator.

6. An expandable airbag cushion assembly as in claim 1, wherein the inflator is remotely located and is connected to the internal inflatable pouch via a tube.

7. An expandable airbag cushion assembly comprising:
an internal inflatable pouch comprised of material having a high stretching coefficient;
an expandable external pocket capable of expanding a certain value before reaching a mechanical limit and stop expanding; and
an inflator for directing gas into the internal pouch,
wherein the airbag cushion assembly is enclosed in a flat panel casing that does not require folding of the expandable external pocket.
